(19) United States
(12) Patent Application Publication
(10) Pub. No.: US 2004/0177664 A1
(43) Pub. Date: Sep. 16, 2004

(54) Production of a high quality organic-based fertilizer

(76) Inventor: Roland Hale, Alfred Station, NY (US)

Correspondence Address: Shlesinger, Fitzsimmons & Shlesinger, Suite 1323, 183 East Main Street, Rochester, NY, 14604, US

(21) Appl. No.: 10/386,669

(22) Filed: Mar. 13, 2003

(51) Int. Cl. C05F 1/00

(52) U.S. Cl. 71/11

(57) ABSTRACT

The subject of this patent application is the formulation and production of an organic based agricultural soil fertilizer/conditioner. The principal product meets the standards of the U.S. Department of Agriculture as 2-2-2, 10-10-10, or other similar mix of fertilizer for land application. The organic based material is municipal sludge from wastewater treatment plants. Sludge material meeting the United States Environmental Protection Agency (USEPA) standards is used. These materials are treated with chemicals and/or an electron beam to render pathogens harmless in the waste material. Globally acceptable macronutients and micronutrients are added to the base material to produce the agricultural fertilizer/conditioner. The macronutrient materials include phosphate rock, hydrated lime, gypsum, potassium hypochlorite, calcium hypochlorite, ammonium nitrate, potash, ammonia prills, and liquid ammonia. The micronutrients include calcium, iron, iodine, magnesium, zinc, selenium, copper, manganese, chromium, molybdenum, potassium, and boron (all in salt form).

It is our objective to reduce dependence on expensive, potentially polluting fertilizers by developing new fertilizers based on sewage sludge.

### FIELD OF INVENTION

A high quality fertilizer, which includes stabilized municipal sludge from secondary wastewater treatment plants, acts as a base for the addition of macronutrients and micronutrients to produce a soil fertilizer more than equivalent to commercial fertilizers. Because organic materials in sewage sludge break down into humus this product is also a good soil conditioner.

During production of the fertilizer, additives of lime, gypsum, potassium hypochlorite, calcium hypochlorite, ammonia prills, phosphoric pentoxide, potassium oxide and liquid ammonia are added to produce 2-2-2 commercial fertilizer, or 5-5-5, and 10-10-10 fertilizer. The macronutrients of lime, gypsum (10% lime), ammonia prills, phosphorous pentoxide, potassium oxide and liquid ammonia combination results in a pH of 12.0-13.5 or over pathogens are destroyed. In addition an electron beam (75-200 watts) can be used to bombard the sewage with high-energy electrons to also destroy pathogens such as bacteria, viruses, protozoa and Helminth worms. The electron beam also reduces organic, toxic, pollutants in the sludge. Mineralization, which is the decomposition of the organic molecules to release inorganic ions, must occur before plants can use these elements. The electron beam, and/or cure time, hastens this process. Sewage with an average composition of approximately 3.3% nitrogen, 2.3% phosphorous and 0.3% potassium is used as a base for this product fertilizer/conditioner. Substances will be added to make up for the initially lower bioavailability of the sludge component and to increase the major components to make, for example, 2-2-2 fertilizer.

### BACKGROUND OF THE INVENTION

A general discussion on the production of a high quality organic based fertilizer follows.

Throughout history, exhausting their fields of nitrogen, phosphorous and potash destroyed civilizations and potash as these nutrients are removed from the soil in large quantities by plants. Nitrogen and water are the most limiting factor in crop output worldwide. The fertilizer described here, produced at modest costs is very competitive with current fertilizers on the market and will decrease on-going costs both for the farmer in the United States as well as farmers in other countries. Fertilizers account for the high yield of crops and the feeding of over one billion people. The most widely used nitrogen fertilizers are produced from chemicals. These fertilizers are very concentrated and expensive. Nitrogen for commercial chemical fertilizers come from ammonia derived from fossil fuels; prices fluctuate depending on the world markets. This fertilizer will depend on sewage sludge for the base, which already contains an average of 3.3% nitrogen.

Municipal Sludge

Municipal Sludge is presently being used for agricultural purposes. Between 40-50% of the sludge being generated is being applied on agricultural land. A typical analysis of the direct application of macronutrients and micronutrients follows. See Table 1, page 7.

The process described herein produces a balanced fertilizer for the farmer. The ratio of nitrate to phosphate to potash can be adjusted for each crop for maximum growth. In addition the organic matter would help maintain the humus in the soil, and acts as a soil conditioner. Presently millions of tons are being landfilled thereby concentrating chemical substances that may or may not be beneficial. Ultimately these chemicals could add to the groundwater contaminates.

Heavy Metals

Only municipal waste streams will be used with this process that are naturally low in quantity of heavy metals. Since each municipality must test for heavy metals in their waste streams we will use their analytical records to screen for our use. That is they must be below the maximum contamination level (MCL) for land application. Wastewater Treatment Plants must determine the source of these heavy metals and work with the source material generator to prevent heavy metals from contaminating the sludge. A nationally certified environmental analytical laboratory will constantly survey the heavy metals concentration. In addition, it will constantly monitor chemicals in the raw sewage; as well as monitor analytes in the production stream. See FIG. 2, page 7.

TABLE 1
TYPICAL COMPOSITION OF RAW AND ANAEROBICALLY
DIGESTED PRIMARY SLUDGES

| | | | Anaerobically Digested | |
|---|---|---|---|---|
| | Raw Primary Sludge | | Primary Sludge | |
| Item | Range | Typical | Range | Typical |
| Total dry solids (TS), % | 2-7 | 4 | 6-20 | 10 |
| Volatile solids (% of TS) | 60-80 | 65 | 30-60 | 40 |
| Grease of fats (ether soluble, % of TS) | 6-30 | — | 5-20 | — |
| Protein (% of TS) | 20-30 | 25 | 15-20 | 18 |
| Nitrogen (N, % of TS) | 1.5-4 | 2.5 | 1.16-6 | 3 |
| Phosphorus (P2O5, % of TS) | .08-2.8 | 1.6 | 1.5-4 | 2.5 |
| Potash (K2O, % of TS) | 0-1 | 0.4 | 0-3 | 1 |
| Cellulose (% of TS) | 8-15 | 10 | 8-15 | 10 |
| Iron (not as sulfide) | 2-4 | 2.5 | 3-8 | 4 |
| Silica (SiO2, % of TS) | 15-20 | — | 10-20 | — |
| pH | 5-8 | 6 | 6.7-7.5 | 7 |
| Alkalinity (mg/l as Ca Co3) | 500-1,500 | 600 | 2,000-3,500 | 3,000 |
| Organic acids (mg/l as HAc) | 200-2,200 | 500 | 100-600 | 200 |
| Thermal content (BTU/lb.) | 6,800-10,000 | 7,600a | 2,700-6,800 | 4,000b |

Appendix A

FIG. 2

Typical Analysis of Sludge Micronutrients

| N | 2.800% dry wgt basis | 1,600 wet (mg/l) |
|---|---|---|
| P | 1.300% | 741.00 |
| K | 1.100% | 627.00 |
| Ti | 0.180% | 103.00 |
| Cr | 0.021% | 12.00 |
| Mn | 0.035% | 20.00 |
| Fe | 1.700% | 970.00 |
| Co | 0.001% | 0.60 |
| Ni | 0.024% | 14.00 |
| Cu | 0.130% | 74.00 |
| Zn | 0.400% | 228.00 |
| Br | 0.002% | 1.10 |
| Rb | 0.004% | 2.30 |
| Sr | 0.037% | 22.00 |
| Y | 0.010% | 5.70 |
| Zr | 0.041% | 23.00 |
| Mo | 0.006% | 3.40 |
| Ag | 0.007% | 4.00 |
| Cd | 0.003% | 1.70 |
| Sn | 0.020% | 11.00 |
| Ba | 0.170% | 97.00 |
| Pb | 0.170% | 97.00 |

Moisture Enhancer

This specialized fertilizer used on crops in field trials produces higher yields than the conventional commercial fertilizer. The higher yields result from an improved texture and structure of the topsoil when the sludge fertilizer is used. Further, the sludge fertilizer provides moisture around the root system of the plants due to the action of deliquesce, a property of absorbing water from moisture in the air. This action tends to keep plant nutrients and water near the roots and reduces leaching and minimizes erosion. Theoretically a 30±1% increased crop yields results. This increase makes our process a better substance over vesting the materials by deposition in a landfill.

It has been noted that organic matter is an excellent reservoir of nutrient availability, including both macronutrients and micronutrients. The organic material in sludge originates in the dietary fiber of humus in this fertilizer. Humus is best described as a brown to black matrix of humic substances produced by the decay of organic matter. The humic and fulvic acid components are the most biochemical active and plant responsive in this sludge fertilizer.

In summary to the above benefits, there is an increase in soil aeration, improved soil workability, reduced soil erosion and an improved draught tolerance besides adding nitrogen to the soil.

Pathogens

Pathogens are organisms or substances capable of causing disease. In our discussion pathogens are living organisms, except where specified. Pathogens infect humans through several different pathways including ingestion, inhalation, and dermal contact. The infective dose, or the number of a pathogenic organism to which a human must be exposed to become infected, varies depending on the organism and on the health status of the exposed individual.

Pathogens that propagate in the enteric or urinary systems of humans and are discharged in feces or urine pose the greatest risk to public health with regard to the use and disposal of sewage sludge. Pathogens are also found in the urinary and enteric systems of other animals and may propagate in non-enteric setting.

The four major types of human pathogenic organisms that may be in municipal sludge are bacteria, viruses, protozoa, and helminths and all may be present in the domestic sewage from a particular municipality. The pathogens in domestic sewage are primarily associated with insoluble solids and the primary wastewater treatment processes, which concentrate these solids into sewage sludge. Nevertheless, the resulting biological sewage sludge may still contain sufficient levels of pathogens to pose a public health and environmental concern. EPA Regulation Part 305 requires sewage sludge to be treated by a Class A pathogen treatment process or a Class B process with site restrictions. Pathogens in sewage sludge could affect animals, including humans by direct contact: touching sludge, walking through an area, handling soil where sludge was applied, and inhaling microbes that became airborne. Indirect contact would result from consumption of contaminated crops, contaminated milk or animals contaminated by grazing; ingestion of water contaminated by runoff, consumption of inadequately cooked fish and contact with sludge by insects, rodents, and the like.

Outside various set conditions, survivability of pathogen decreases. Some of the factors, which influence the survival of the pathogens, include pH, competition from other microorganisms, sunlight, contact with host organisms, proper nutrients and moisture level.

There is a probability of human injection from protozoa and helminths, usually referred to as parasites in municipal sludge. Parasites are of health significance in land application practices. Our system of treating parasites disallows the reinjection of the fertilizer through protozoan cysts or helminth ova. Epidemiolgical studies suggest little risk to human health from parasites in treated sludge applied to land.

Sewage Sludge Pathogens to Produce Class A Biosolids:

Pathogens

The four major types of human pathogenic organisms in sewage or sludge are bacteria, viruses, protozoa, and helminths. We have investigated different types of domestic sewage from the following sources:

1. Wellsville Waste Water Treatment Plant, containing commercial, manufacturing, hospital, and community waste

2. A small town with general municipal waste

3. Blue Plains sludge from Alexandra, Va. and Washington, D.C. containing multiple sources in large quantities. We investigated primary waste sewage sludge rather than wastewater.

Bacteria

Fecal coliform and E. coli bacteria were used as indicators for the absence or presence of bacterial pathogens in sewage sludge. Fecal coliform bacteria are abundant in human feces and therefore are always present in untreated sludge. Their densities decline when exposed to adverse conditions, (such as high pH and high temperature). When processing sludge, studies of aerobic or anaerobic digestion of sludge have shown the reduction of the pathogens will be significant and sufficient. We have focused on the regrowth of pathogenic bacteria. With our additives and conditions of processing sludge, we have not found regrowth of pathogens to be a problem. In outdoor tests of time we have not found pathogens and we conclude that environmental ammonia and hypochlorite activates Cryptosporidium sp oocytes. A high pH, along with chemical additives, increases the free ammonia concentration in the sludge inactivating these oocytes. It should be noted that protozoa pathogens are expected to be reduced. Restrictions of sludge fertilizer applications are written into a regulation that concerns the types of crops grown, etc.

Class A Biosolids-Pathogen Requirements

Conditions requiring Class A sludge are:

1. Biosolids that are solid or given away in a container for land application

2. Bulk biosolids for lawns and home gardens.

Requirements to reduce pathogens below detectable limits are:

| | |
|---|---|
| 1. Salmonella sp- | <3 MPN/4 g biosolids |
| 2. Enteric viruses- | <1 PFU/4 g of biosolids |
| 3. Viable helminth ova- | <1 helminth ova/4 g biosolids |

Monitoring of fecal coliform<1000 IVIPN/g total solid

It should be noted that the timing should be at the last practical monitoring point before the biosolids are land applied.

Sewage Sludge Treated in a High pH Temperature Process

1. Elevating the pH to greater than 12 and maintaining for more than 72 hours

2. Maintaining the temperature above 52° C. (126° F.) throughout the sewage sludge for at least 12 hours during the period the pH<12

3. Air-drying to over 50% solids after the 72-hour period of elevated pH.

4. Hydrated lime, calcium hydroxide, quicklime, calcium oxide, or lime containing kiln dust or fly ash may be used for a pH>12 for 2 hours may be used to reduce bacterial and viral densities effectively.

Field experience has shown that the application of lime stabilized after the pH has dropped below 10.5 may, in some cases, cause odor problems. It is recommended that biosolids applications take place while the pH remains elevated. If this is not possible, and the odor problems develop, alternate management practices in the field include injection or incorporation of top dressing the biosolids with additional lime. Lime stabilization can reduce bacteria and viral pathogens by 99% or more. Such alkaline conditions have little effect on hardy species of helminth ova; however, our basic formula will kill the ova. (See “ODOR” pg. 23)

Note: A dose of 1 megarod of energy or more will also reduce pathogenic viruses, bacteria and helminths to below detectable levels. Gamma rays can penetrate sewage sludge of substantial thickness as can an electron beam apparatus.

Inactivation of Ascaris Eggs in Sewage Sludge by the Addition of Hydrated Lime and Ammonia

To test the effectiveness of ammonia, hydrated lime, and hypochlorites for the inactivation of Ascaris eggs in sewage sludge, viable eggs of Ascaris suum (pig Ascaris) were added to freshly collected sewage sludge. A portion of the sludge was set aside as a control and the remainder was treated with hydrated lime and ammonia. The treated sludge was held at room temperature for 24 hours and after seven days was examined microscopically and checked for the condition of the eggs and the development of larval stages.

Processing of samples preliminarily to microscopic examination started with addition of water to a sewage sample followed by homogenization. The proportion of water to sludge varied according to the estimated water content, but following homogenization a solution fluid containing approximately 50 g of sludge was transferred to a plastic container and brought up to a volume of 750 ml. With buffered phosphate solution containing 1% “limbro” laboratory detergent (1% 7×). The samples were allowed to remain overnight with separation into two layers, sediment below and sediment above. The supernatant fluid was removed and the sediment transferred to a blender and brought up to 400 ml with water and blended a second time. The samples were then transferred to a container and brought up to 750 ml, stirred and allowed to settle for at least four hours, usually overnight.

Sediment from each sample was transferred to 1.5 ml centrifuge tubes (three tubes per sample) and centrifuged at 800×g for five minutes. The supernatant fluid was removed and replaced with zinc sulfate solution sp.gr.1.20. Sediment was resuspended and centrifuged again for five minutes. Additional zinc sulfate solution was added to each tube and a microscope preparation made with a 22 ml square cover glass. Microscope preparations were examined at a magnification of 100×.

In a test run approximately 2 million Ascaria suum eggs were thoroughly mixed with 5 pounds of sewage sludge. One half pound of sludge was removed for a control and the remainder of mixed with a pound of hydrated lime and three ounces of 35% ammonia solution. The sludge was allowed to remain for 24 hours before processing. One set of samples was processed after the 24-hour period and a second set 7 days later. In the first set there were about equal numbers of eggs with mammalated cortex and eggs with the mammalated layer reduced of absent in both the treated and control samples. In the second set there was a clear difference between the treated and untreated samples. In the untreated sample there were approximately equal numbers of eggs without the mammalated layer with what appeared to be an intact cell within and eggs with a clear cortical shell containing a developing larval form. In the treated sample there were no embryos and only occasional eggs that were clear and did not appear to have a viable cell within. An additional set of samples is currently being processed to check the appearance of eggs after two and four days. Results to date, however, indicate that the lime and ammonia treatment is effective for the inactivation of Ascaris eggs.

To extend the work covered in the preliminary report, a second run was set up to examine the effect of sludge treatment on Ascaris eggs over a longer period of time. 10 lbs. of freshly collected sludge was treated with 1.2 lbs. of commercial lime, 0.24 gal. of ammonia and 2 lbs. of gypsum to duplicate the standard treatment of 1 ton of sludge. The gypsum, not used in the previous study, was an additional ingredient for the process. Approximately 1 million Ascaris eggs were added to 2 lbs. of treated sludge and approximately 0.5 million eggs were added to 1 lb. of untreated sludge. The material was maintained in plastic containers at 19-21° C. Ascaris suum eggs for this work were obtained through Dr. Timothy Miller at the Cornell veterinary college.

Samples were taken and slides prepared in a manner similar to previous work. Sludge was homogenized with water, transferred to a plastic container and brought up to 750 ml. Volume with phosphate buffer stirred and allowed to settle overnight. The supernatant was removed and sediment from both treated and untreated material stored in plastic containers at ambient temperature (18-21° C.). Preparations for microscopic examination were made by transferring 15 ml. of sediment for both treated and untreated material into three 15 ml centrifuge tubes and centrifuging for 5 minutes at 800×gr. After removal of the supernatant the sediment was re-suspended in zinc sulfate solution (Ovosol sp>1.20) and centrifuged again. Additional zinc sulfate solution was added and a microscope preparation made with a 22 ml cover glass. Total egg counts for three slides each of untreated and treated material were made over a period of 47 days with results (appendix a).

Inactivation of Ascaris Eggs

To extend the work covered in the preliminary report a second run was set up to examine the effect of sludge treatment on Ascaris eggs over a longer period of time. 10 lbs. of freshly collected sludge was treated with 1.2 lbs of commercial lime, 0.24 gal of ammonia and 2 lbs of gypsum to duplicate the standard treatment of 1 ton of sludge. The gypsum, not used in the previous study, was an additional ingredient for the process. Approximately 1 million Ascaris eggs were added to 2 lbs. of treated sludge and approximately 0.5 million eggs were added to 1 lb. of untreated sludge. The material was maintained in plastic containers at a 19-21 degrees C. Ascaris suum eggs for this work were obtained from Dr. Timothy Miller at the Cornell veterinary college.

Samples were taken and slides prepared in a manner similar to previous work. Sludge was homogenized with water, transferred to a plastic container and brought up to 750 ml. Volume with phosphate buffer, stirred and allowed to settle overnight. The supernatant was removed and sediment from both treated and untreated material stored in plastic containers at ambient temperature (18-21° C.). Preparations for microscopic examination were made by transferring 15 ml. of sediment for both treated and untreated material into three 15 ml. centrifuge tubes and centrifuging for 5 minutes at 800×gr. After removal of the supernatant the sediment was resuspended in zinc sulfate solution (Ovosol sp>1.20) and centrifuged again. Additional zinc sulfate solution was added and a microscope preparation made with a 22 ml, cover glass. Total egg counts for three slides each of treated and untreated material were made over a period of 47 days with the following results:

| Time Sample | No. of Eggs | Single Cell | Two Cell | >Two Cells |
|---|---|---|---|---|
| 24 Hrs Treated | 85 | 85 | | |
| Untreated | 102 | 102 | | |
| 4 day Treated | 58 | 58 | | |
| Untreated | 65 | 65 | | |
| 11 day Treated | 84 | 84 | | |
| Untreated | 133 | 133 | | |
| 15 day Treated | 145 | 145 | | |
| Untreated | 207 | 176 | 31 | |
| 20 day Treated | 304 | 304 | | |
| Untreated | 261 | 240 | 21 | |
| 25 day Treated | 217 | 217 | | |
| Untreated | 190 | 128 | 61 | 1 |
| 33 day Treated | 200 | 200 | | |
| Untreated | 105 | 54 | 41 | 10 |
| 39 day Treated | 205 | 205 | | |
| Untreated | 216 | 87 | 117 | 12 |
| 47 day Treated | 392 | 392 | | |
| Untreated | 105 | 63 | 14 | 28 |

Both mammalated and decorticate forms were observed with the decorticate forms about one half to one third of the total. In the 20 and 25 day samples active larval forms of a species other than Ascaris were seen in the untreated material in addition to the developing eggs.

Appendix A:

Ascaris Egg Counts

| Time (days) Sample | of Eggs | Single Cell | Two Cells | >Two Cells |
|---|---|---|---|---|
| Treated | 85 | 85 | | |
| Untreated | 102 | 102 | | |
| 4 Treated | 58 | 58 | | |
| Untreated | 65 | 65 | | |
| 11 Treated | 84 | 84 | | |
| Untreated | 133 | 133 | | |
| 15 Treated | 145 | 145 | | |
| Untreated | 207 | 176 | 31 | |
| 20 Treated | 304 | 304 | | |
| Untreated | 261 | 240 | 21 | |
| 25 Treated | 217 | 217 | | |
| Untreated | 190 | 128 | 61 | |
| 33 Treated | 200 | 200 | | |
| Untreated | 105 | 54 | 41 | 10 |
| 39 Treated | 205 | 205 | | |
| Untreated | 216 | 87 | 117 | 12 |
| 47 Treated | 392 | 392 | | |
| Untreated | 105 | 63 | 14 | 28 |

Odor Control

Odor is defined as the perception of smell or the stimulus of smelling via the receptors of the olfactory epithelium within the upper nasal cavity. Differences between psychologically pure and impure odors are neglected in most problems of odor control as in community air pollution applications, where irritants and stenches are grouped together as objectionable atmospheric contaminants that ought to be removed.

The odor problem in this patent is confined in space and results from 63.0-77.0% moisture/27-33% solids of raw sewage from a municipal wastewater treatment plant.

Odors can be characterized by their intensities, their qualities, and their affective tones or pleasant-unpleasant attributes. The term odor control describes any process that makes olfactory experience more acceptable to people. There are thus two distinctly differences to odor control but the one we shall incorporate into this patent is as follows: the odorant will be changed in quality and reduced in quantity (less than 95-98%) so that it becomes more pleasant and acceptable to people. This method modifies odors by chemical conversion to products whose odor is more pleasant and by odor counteraction and masking. Masking and counteraction will be used to modify odors from the wastewater treatment plant. The current exacerbation of the public's reaction to air pollution is accompanied by a sharp decrease in willingness to tolerate offensive odors.

Methods of Odor Control: The odor source is altered so as to make the resultant odors less intense and more tolerable. Our method substitutes low-odor solvents and reactants for highly odorous ones. In one embodiment, agricultural lime, ammonia prills and liquid ammonia are used to modify odors; in another embodiment commercial odor neutralizers both natural and organic are used in the commercial preparation, “X—O”. In yet another embodiment calcium hypochlorites are used to decrease the odor over 98%.

Air oxidation is another method we will use as the complete oxidation of odorants in air is a fully effective method of odor control. The equipment used is a direct-flame incinerator and catalytic combustion system. The odorous air is mixed with direct flame combustion gases. Flame detention times are usually 0.3 seconds or longer.

Chemical conversion of odorants is accomplished by using oxidizing agents. Oxidants used are ozone, permanganates, hypochlorites and chlorine. Each oxidizing agent has been appraised in terms of odor abatement. Permanganates will be used by direct treatment of odor sources and by scrubbing with aqueous permanganate solutions. We have also found that granular beds of adsorbant impregnated with permanganate is efficiently effective. The oxidizing effectiveness of permanganate depends on the pH of the medium. Again, the oxidizing agents of calcium and potassium hypochlorite is very effective (98%) in reducing odor. The irradiation of the odorant using ultraviolet rediation in the electromagnetic radiation is in the range of 1850-2000 Angstroms.

Counteracting and masking agents. In another embodiment we control odors by modifying their quality by means of admixture with more pleasant odors under conditions that do not involve any chemical changes. Our processes of counteraction or cancellation and odor masking or reodorization are used. We use a proprietary cancellation agent consisting of an organic ester. Our odor modifier is applied with pressure atomization through spray nozzles. We modify using a diluted concentration of about 1% emulsified in water.

Headspace Analysis Using Gas Chromatography (HP5890) and Mass Spectrometer (HP5971)

Remediation of Pathogens and Odor

Research involving the use of municipal sludge for the manufacture of a commercial fertilizer includes a period of a major thrust of odor reduction and pathogen remediation.

Phase I: Odor Reduction of Municipal Sludge

Introduction

The research was performed to find a reliable way for eliminating the sludge odor.

In preliminary experiments with GC-MS we found that the most probable source of the odor was dimethyldisulfide. The peak of this material was found in the chromatogram of sludge. It appears in the chromatograms with retention times of 1.94 and 1.74 minutes. The peak was well identified through its mass spectrum. Line 94, which is the strongest in the mass-spectrum for this material, was used for evaluating the quantity in integration units.

The main ideology of the research was to find a chemical reagent, which when reacted with sulfur-containing organic compounds converted them into materials without odor. Two types of possible reactions were investigated: oxidation of sulfides and mercaptanes with oxidizers and treatment with alkaline solutions with high pH.

As an oxidizing agent the following reagents were investigated: KNO₃, H₂O_{2,} H₂SO₄, CaOCl₂, and Sanitizer Super Soluble™ (BIO-LAB, Inc.). Alkaline solutions researched included ammonia and calcium hydroxide.

Evaluation of the Treatment

Effectiveness of the treatments was evaluated through the GC-MS analysis of the treated and untreated sludge. Sludge (5.0 g) was placed into a 44 ml vial. After heating to 60.0° C. for 5.0 minutes a probe of gas was taken from the vial (0.5 ml) and injected into the GC-MS.

GC-MS Instrument and Parameters

Hewlett-Packard (HP) GC 5890 coupled with an HP 5971 mass-spectrometer. The system incorporates an electron beam as an ion source. Ions are filtered through a glass with silver-coated quadruples.

A DB5MS capillary chromatographic column is used and the MS is tuned with PFTBA in a Scan Mode (tune file: BFB.U).

All details of instrument parameters are attached with an upper operational printout.

In preliminary experiments two models of chemical compounds were used: dimethylsulfide (CH₃—S—CH₃) and dimethyldisulfide (CH₃—S—S—CH₃). The attached file (C:\CHEMPC\DATA\102202D.D) reveals the following:

The probe of gas (air, 0.5 ml) containing about 20 μg/L of dimethyldisulfide was analyzed with GC-MS and both compounds have a common peak of peak with a retention time of 1.94 and 1.74 minutes. This chromatographic peak contains strong ion-peaks with m/z=94 (94-ion).

For further characterization the peak area of the 94-ion was selected. The calibration was performed using dimethyldisulfide. A calibration curve is presented in the attached data. Calibration verification is also presented in the data with theoretical concentration of approximately 40 ug/L. The instrument's result was 37 ug/L.

Sample Preparation

In the first series, 6.00 g (±0.05) of the sludge with the addition of 10.0 ml of distilled water was used. For the treatment, we used potential oxidizers such as KNO₃ and H₂SO₄ in different combinations. We found some reduction of the peak after 1.93 minutes of treatment with sulfuric acid. However, the odor was not completely removed.

In the second series we used 5.00 g (±0.01) of the sludge with no dilution. For the treatment we used additions of hydrogen peroxide (30%) −0.5 ml, sulfuric acid (98%), −0.5 ml, a combination of hydrogen peroxide and 0.5 ml and sulfuric acid 0. ml, ammonia (54%) −0.5ml, calcium hypochlorite −0.5 g. The peak areas are shown in the table below

Table for Phase I:

Peak area in integration units (IU) for line 94 at retention a time of 1.93 and 1.74 minutes.

| | Treatment | | | | | |
|---|---|---|---|---|---|---|
| | — | H₂O₂ | H₂SO₄ | H₂O₂ + H₂SO₄ | NH₃ | CaOCl₂ |
| Peak Area | 39,500 | 35,000 | 8,400 | 26,200 | 3,650 | 4,860 |

It should be noted that when using ammonia, the odor was not entirely removed, but the treatment with sodium hypochlorite was effective. The reason could be in the nature of the odor not being just one substance, but a mixture of different substances.

Phase II:

Subject: Determination of the Lowest Concentration of Calcium Hypochlorite for Odor Elimination

The results of the determination of the lowest levels of calcium hypochlorite additions to eliminate odor are presented in the table below. The effectiveness of the additions is evaluated through decreasing the area of 94-ion signal with retention time around 1.94 minutes. We also investigated the influence of time.

The samples of the sludge (approximately 5.0 g) were placed into the vials and treated with additions of CaOCl₂ at a temperature of 60.0° C.

| Bottle # | Sludge, g | CaOCl₂, g | Area | Time, min | Notes |
|---|---|---|---|---|---|
| 2 | 5.0458 | — | 298,361 | 2 | Odor |
| 3 | 5.0803 | 0.0257 | 38,988 | 2 | Odor |
| 5 | 5.0776 | 0.0256 | 14,127 | 5 | Odor |
| 9 | 5.0716 | 0.0248 | 16,067 | 10 | Odor |
| 10 | 5.0025 | 0.0513 | 3,754 | 5 | No Odor |

Conclusions:

1. The amount of CaOCl₂ must be at the level of 1.0%.

2. Treatment time at 60° C. must be 5.0 minutes.

Phase III:

Results

KNO₃, H₂O₂, and H₂SO₄ do not show any activity in the reduction of the sludge odor. We do not present the chromatograms of treated sludge in Phase III.

Calcium hypochlorite and other hypochlorites are effective in elimination of the odor. Its action was examined intensely and the lowest effective concentration was determined. The results are presented. From this data we have accepted 0.5% weight CaOCl₂ as the lowest effective concentration for eliminating the odor. This data also contains replicates. Addition of hypochlorite reduced the dimethyldisulfide content from 3.5 ug/L to 0.5-0.6 ug/L (0.5% weight).

Another active reagent that was similar to hypochlorite tested was Sanitizer Super Soluble™. Its effective concentration was also at level 0.5% weight. It was used as a water solution (1:10 on weight basis). The results for treated and untreated samples are presented in the following table.

Experiments with ammonia and calcium hydroxide conditioning demonstrate the decreasing of the 94-ion peak with retention time of 1.94 minutes. But the odor still exists due to formation of other sulfide compounds that produce the odor. Results of common action of the Sanitizer and ammonia are presented in the table. Without oxidizing characteristics these reagents are not effective for removing the odor.

Phase 4: Subject: Reproducibility of Results

The reproducibility of the treatment with calcium hypochlorite Ca(OCl)₂ (CHC) on sludge was investigated. In all experiments, 5.0 g of sludge in a special vial was treated with an addition of percent of weight of odor reducer (0.05 g). After heating to 60.0° C. for 5.0 minutes, a sample of vapor over the sludge was taken and injected into the GC/MS. Total Ion Chromatograph signal with retention time 1.74 minutes were used for evaluation of the treatment corresponding to dimethylsulfide). The peak at 1.74 minutes replaces the peak at 1.93 minutes as we changed parameters.

The results obtained are in the file: data-0-12.hls (MS Excel File). Statistical evaluation gives a confidence interval ±0.85 for an average meaning 98.23% of relative reduction of the peak area with a probability of 95%. It proved that treatment with hypochlorites provides a reliable reduction of sludge odor.

The influence of different additives on the sludge pH was also evaluated. The results are shown in the attached file: data-12-28.hls (MS excel file). Untreated sludge has a pH from 6.23-6.49. Calcium sulfate (gypsum) does not change the sludge pH. Urea increases the pH to a level of 8.3-8.45. Urea in combination with calcium sulfate is less effective. The most effective additive is calcium oxide which increases pH to 11.8.

In all experiments the treated sludge, even after a time period of a week, had no intense odor.

The addition of calcium hypochlorite does not affect the sludge pH, as was noted with previous experiments.

Calculations:

We calculated the amount of calcium hypochlorite [Ca(ClO)₂] or equivalent needed per ton of sludge.

Data: 5.0 g of sludge required 0.0513 g of calcium hypochlorite to eliminate organic sulfur odor.

To: upgrade with dimensional analysis . . .

$$\begin{matrix}A . ) & 5.0 sludge \times \frac{1 lb .}{454 g} \times \frac{1 ton}{2000 lb} = 5.5 \times {10}^{- 6} \\ B . ) & 0.0513 {Ca ( ClO )}_{2} \times \frac{1 lb .}{453 g} = 1.1 lbs . of calcium hypochlorite \\ C . ) & \frac{1.1 lbs {Ca ( ClO )}_{2}}{5.5 \times {10}^{- 6}} = 20.5 lbs . {Ca ( ClO )}_{2} \text{/} Ton Sludge\end{matrix}$$

Influence of Additives on Sludge PH

Treatments with urea, CaSO₄, CaO

| Sludge | Urea, g | CaSO₄ | CaO | pH |
|---|---|---|---|---|
| 5.0473 | 0 | 0 | 0 | 6.23 |
| 4.9433 | 0 | 0 | 0.5 | 11.5 |
| 5.1077 | 0.5 | 0 | 0 | 8.32 |
| 5.0998 | 0 | 0.5 | 0 | 6.25 |
| 5.0286 | 0.5 | 0.5 | 0 | 7.89 |
| 5.0544 | 0 | 0 | 0 | 6.49 |
| 5.1069 | 0 | 0 | 0.5 | 11.65 |
| 5.0022 | 0.5 | 0 | 0 | 8.45 |
| 5.0273 | 0.5 | 0.5 | 0 | 7.51 |
| 5.1097 | 0.5 | 0 | 0.5 | 11.69 |
| 5.0490 | 0 | 0.5 | 0 | 6.3 |
| 5.0574 | 0 | 0.5 | 0.5 | 11.64 |

Results of the Sludge Treatment

Treatments of the sludge

Initial Total ion integration for untreated sludge is 376025

| Peak Area | Abs. Reduction | Relative reduction |
|---|---|---|
| 7604 | 368421 | 97.98 |
| 14428 | 361597 | 96.16 |
| 5502 | 370523 | 98.54 |
| 12814 | 363211 | 96.59 |
| 4276 | 371749 | 98.86 |
| 3638 | 372387 | 99.03 |
| 3116 | 372909 | 99.17 |
| 2000 | 374025 | 99.47 |

Average Relative Reduction: 98.23

Standard deviation: 1.23

Confident interval 95%: 0.85

Relative reduction of the peak is 98.23±0.85% with probability of 95%.

Appendix A GC/MS Instrumental Prints for Pages 1-24 (Indicating the Quantity of Research Required for this Thesis)

1. Calibration of an External Standard of dimethyldisulfide.

2. A. Chromatogram of 6.0 g Blue Plains raw sample plus 10.0 ml distilled water.

B. Also verification with a standard curve INTEGRATION UNITS vs. CONCENTRATION

3. Standard peak of Odor from 5.0 g of raw Blue Plains sludge with a general proportionality constant of 100% of odor equivalent to 300,000 I.U.s.

4. HP Gas Chromatograph/Mass Spectrometer acquisition parameters utilized in this research project.

5. Qualitative report settings.

6. Restandardization of odor peak with 5.0 g of raw Blue Plains sludge and an abundance trace of approximately 421,300 integration units.

7. A. Calibration of a treated odor reducer sample from Blue Plains indicating a retention time of 1.96 with a quantity of 0.6 micrograms/liter.

B. Chromatogram indicating an odor reduction of over 90%

8. An updated calibration of an odor reducer/Blue Plains sludge with an External Standard Report.

9. A. Chromatogram indicating a 94% reduction of odor using an odor reducer

B. Chromatogram indicating a 92% reduction of odor using an odor reducer.

10. Another calibration update to indicate good calibration during procedures.

11. Chromatogram indicating approximately 93% reduction

12. Calibration update; quantitation settings, standard dimethyldisulfide.

13. Retention time of dimethyldisulfide@ 1.74 minutes; calibration equivalency equal to 100% and subsequently treated with odor reducer.

14. Updated calibration and ID's for peak 1.74 minute retention time.

15. 5.1073 g untreated Blue Plains sludge with an integration of 467,144 integration units.

16. 5.0674 g sludge treated with 0.515 g of odor reducer.

17. 5.1641 g sludge treated with 0.053 g of odor reducer

18. 5.1111 g sludge treated with 0.508 g of odor reducer with 1,217,669 IU's

19. 5.1119 g sludge plus 0.0525 g odor reducer with 1,068,423 IU's

20. 5.145 g sludge treated with 0.0508 g odor reducer

21. 5.1454 g sludge treated with 0.0508 odor reducer with 1,284,625 IU's

22. 5.0233 g sludge treated with 0.0513 g odor reducer with 1,284,625 IU's

23. 5.0233 g sludge treated with 0.0503 g odor reducer with 807,349 IU's

24. 5.0944 g sludge untreated, replicate 011103 c.

Discussion on Formula

Various formulas are considered in this patent. The uses of each ingredient in the following formula will be delineated below. As a part of this invention we have, through research, come up with specifics in terms of the total product as follows:

Formula A (pg. 38)

Our patent uses hydrated lime which is produced by adding water slowly to a crushed or ground quicklime, CaO, forming calcium hydroxide Ca(OH)2. CaO may also be used separately. Lime is used to adjust the mix to a higher pH of 12 (range 12.0-13.5) to reduce the number of pathogens in the sludge. The hydrated lime also combines with a weak acid that elevates the temperature to around 125° F. (range 100° F.-150° F.) to help destroy pathogens. Lime neutralizes the soil when this sludge fertilizer is applied to the land. Plants will not grow well when the acidity of the soil is high. Lime is also used to reduce the odors of the sludge by reacting with organic odors. Lime is an important additive in formula A. A weak acid when mixed with lime produces an exothermic reaction, again reducing pathogens.

Macronutrients ammonia prills and liquid ammonia are used to destroy pathogens also as well as adding nitrate to the soil. Nitrogen as a component of fertilizer is in the nitrate form (NO₃). Phosphate and Potash are also added to the mix to provide phosphorous pentoride and potassium oxide necessary for plant growth.

Formula B pg. 38

Formula B is similar to Formula A and was used to test the status of the pathogens in the mix. It was concluded that the fecal coliform and E-Coli were destroyed in the sludge fertilizer along with the viruses and parasites (protozoa and helminth). The bacteria tests ere carried out in an incubator at 35° C. (range 35±0.05° C.) for 24 hours using Colilert (by Idexx) as an indicator. The test was negative for fecal coliform and negative for E-Coli.

Formula C pg. 39

Formula C was phased down to a lab bench size for the ease of sampling and analysis. The results were the same as Formula A above as it is an equivalent to Formula A. No pathogens were found in the fertilizer mix.

Formula D pg. 39

Formula D is a modification of formula C whereby an increase in the percentage of sludge was made. Again no pathogens were found in the fertilizer mix.

A

1 Ton (range 0.9-1.1ton) of Sludge

300# (range 270.0-300.0#) of Hydrated Lime

5# (range 4.0-6.0#) of Sulfamic Acid

30# (range 27.0-33.0#) of NH3 Prills

30# (range 27.0-33.0#) of P2O5

30# (range 27.0-33.0#) of K2O

2.5 Gallons (range 2.20-2.80 gal) of NH3/Ton

Incubate 24 hours.

B

1 Ton (range 0.9-1.1ton) of Sludge

300# (range 270.0-300.0#) of Hydrated Lime

30# (range 27.0-33.0#) of NH3 Prills

2.5 Gallons (range 2.20-2.80 gal) of NH3

C

3.5# (range 3.0-4.0#) of Sludge

0.5# (range 0.5-0.7#) of Hydrated Lime

0.25# (range (0.22-0.28#) of Potassium Oxide

0.25# (range 0.22-0.28#) of Phosphorus Pentoide

0.125# (range 0.075-0.180#) of Ammonuim Nitrate

0.5# (range 0.50-0.70#) of Liquid Ammonia

D

5# (range 4.50-5.50#) of Sludge

8 oz (range 6.0-10.0 oz) of Hydrated Lime

3 oz (range 2.0-4.0 oz) of Ammonia_{(liquid)} AA7

4 oz (range 3.50-4.50 oz) of Ammonia Prills

4 oz (range 3.50-4.50 oz) of P₂O₅

4 oz (range 3.50-4.50 oz) of K₂O

0.5 oz (range 0.40-0.60 oz) of Sulfamic Acid

Benchtop Formulations Used for Bacteria Status

The status was tested using Colilert by IDEXX Laboratories, Inc. Colilert is used for the simultaneous detection and confirmation of total Coliform and E-Coli by defined Substrate Technology.

Trial 1 (−/−) p. 41

This trial includes the use of hydrated lime, ammonia prills and household (4%) Chlorox (HClO) with sludge as a formula to destroy pathogens in sludge. The ingredients were mixed and let set for 2 hours and then tested.

The test method used was by obtaining a “seed” of about 3 grams, stirring it into sterilized, 100 ml jars, filled with sterilized water, and unit doses of the substrate were added and stirred. Each test sample was incubated at 35±0.5° C. for 24 hours. Fecal Coliform presence is indicated by a yellow color in the 100 ml jar. At the same time an ultraviolet light is used to detect E-Coli: If E-Coli is present, florescence occurs in a dark room which indicates a presence.

In trial 1, neither fecal coliform nor E-Coli was present. No presence is indicated by a negative sign (−/−) i.e., negative (−) for fecal coliform and negative (−) for E-Coli.

Trial 2 (−/−) p. 42

Trial 2 consists of a trial formula similar to Trial 1 except that the hydrated lime and ammonia prills are half strength. The results were the same (−/−).

Trial 3 (−/−) p. 42

In Trial 3 we added more components which ultimately be in the combines sludge fertilizer. Phosphate (P₂O₅) and potash (K₂O) were added along with liquid ammonia as a part of the treated sand. The impregnation of liquid ammonia (NH₃) in sand decreases the volatility of the ammonia and yet the sand also helps keeping the consistency of the final product for spreading on land use.

Trials 4 and 5 were used to document the components of hydrated lime and hypochlorous. It was determined that both played a role in the destruction of pathogens in sludge. (page 42 and 43)

Production of Fertilizer from Sludge in the Laboratory

| | |
|---|---|
| TRIAL 1 | |
| 9 oz (range 8.0-10.0 oz) Sludge | Transfer small section into |
| 1 oz (range 0.90-1.10 oz) of Hydrated Lime | Bacteria Bottle |
| 1 oz (range 0.90-1.10 oz) Ammonia Prills | Add Colilert |
| 1/2 oz (range 1/4-3/4 oz) 4% Chlorox | Incubate at 35° C. for 24 Hours |
| TRIAL 2 | |
| 9 oz (range 8.0-10.0 oz) Sludge | Transfer small section into |
| 0.5 oz (range 4.50-5.50 oz) Hydrated Lime | Bacteria Bottle |
| 0.5 oz (range 4.50-5.50 oz) Ammonia Prills | Add Colilert |
| 0.5 oz (range 4.50-5.50 oz) Hypochlorous Acid | Incubate at 35° C. for 24 |
| | Hours |
| TRIAL 3 | |
| 9 oz (range 8.0-10.0 oz) Sludge | Transfer small section into |
| 1 oz (range 0.90-1.0 oz) Hydrated Lime | Bacteria Bottle |
| 0.5 oz (range 4.50-5.50 oz) Phoshate & Potash | Add Colilert |
| 0.5 oz (range 4.50-5.50 oz) Ammonia Prills | Incubate at 35° C. for 24 |
| | Hours |
| 0.5 oz (range 4.50-5.50 oz) Hypochlorous Acid | |
| 1.5 oz (range 1.20-1.80 oz) Treated Sand with Liquid Ammonia | |
| TRIAL 4 | |
| 9 oz (range 8.0-10.0 oz) of Sludge | Transfer small section into |
| 2 oz (range 1.50-2.5 oz) of Hydrated Lime | Bacteria Bottle |
| 1 oz (range 0.90-1.10 oz) of Chorox | Add Colilert then incubate |
| | at 35° C. for 24 hours |
| TRIAL 5 | |
| 9 oz (range 8.0-10.0 oz) of Sludge | Transfer small section into |
| 1 oz (range 0.90-1.10 oz) Chlorine | Bacteria Bottle |
| | Add Colilert then incubate |
| | at 35° C. for 24 hours |

Testing for Coli Form and E. Coli Bacteria Trials

Trails Using Solid Hypochlorous Acid, Alcohol, and Formaldehyde as Additives.

### DISCUSSION

Introduction

The results of the addition of 4% liquid hypochlorous acid affected the 30% solid/70% moisture ration with the result of a sloppy product, but with good destruction of pathogens. Trials with solid (powdered) hypochlorous acid ensured.

Trial A (−/−)

Trial A consisted of combining sludge (258 g) (range 236.0-260.0 g), calcium hypochlorite (25 g) (range 23.0-27.0 g), hydrated lime (50 g) (range 47.5-52.5 g) and ammonia sand mix (45 g) (range 41.50-49.50 oz). When the material was mixed the mix temperature went to 92° F., one hour later the temperature was 98.8° F., and two hours later 89° F. While the temperature did not reach the 122° F. for 15 seconds the mix did destroy the pathogens in the sludge samples.

Trial B (−/−)

Trial B is the same as Trial A except that the ammonia sand mix was absent. Sludge (260 g) (range 247.0-273.0 g), calcium hypochlorite (20 g) (range 18.0-22.0 g), and hydrated lime (50 g) (range 47.0-53.0 g) were mixed with a resulting temperature of 105° F. (range 100°-110° F.).

Trial C (−/−)

Trial C consisted of using calcium hypochlorite with formaldehyde. Trial C consist of sludge (248 g) (range 236.0-260.0 g) solid hypochlorous acid (23 g) (range 21.0-25.0 g), and formaldehyde (10×) (range 8.0-12.0×). The above mix was placed in a heated oven a 80° F. (range 80-90° F.) for 2 hours (range 1.50-2.50 hours). A seed was used to determine if the pathogen presence/absence using Standard Operating Procedures (SOPs). Fecal coliform and E-Coli are not found but were present in the original mix.

Trial K (−/−)

Sludge (500 g) (range 475.0-525.0 g), HClO (2.5 g) (range 2.30-2.70 g), Lime (75 g) (range 71.0-79.0 g), Ammonia/sand mix (2.5 g) and 10 ml (range 8.0-10.0 ml) of Ethyl Alcohol (ETOH) was mixed together and let stand for 10 hours (range 9.0-11.0 hours) at room temperature (21° C.). After that time, the material was tested and no bacteria was found using the Colilert Method.

Trial L (−/−)

The trial L mix is similar to trial L: this time sludge (250 g) (range 238.0-262.0 g), HClO (20 g) (range 19.0-21.0 g), lime (75 g) (range 71.0-79.0 g), ammonia/sand mix (2.5 g) (range 2.30-2.70 g) and ETOH (10 ml) (range 8.0-12.0 ml) was mixed and let stand for 2 hours (1.50-2.50 hours). The Colilert method was used to determine the presence/absence of fecal coliform and E-Coli, and none were present.

Trial M

Sludge (250 g) (range 238.0-262.0 g), HCLO (2.5 g) (range 2.30-2.70 g), Lime (50 g) (range 48.0-52.0 g), and ammonia (20 g) (range 19.0-21.0 g) sand were mixed and stored for 2 hours and tested for P/A of fecal coliform and E-Coli. No fecal coliform (−) nor E-Coli (−) was found.

Trial N (−/−)

Sludge (50 g) (range 47.5-52.5 g), ammoniated sand (8 g) (range 7.60-8.40 g), ETOH (10 ml) and ammonia Liquid (20 ml) (range 19.0-21.0 g) were mixed and stored for 2 hours (range 1.50-2.50 hours) at room temperature. Using SOPs for the Colilert tests no bacteria was found.

Samples: Modified with Solid Hypochlorous Acid

258 Grams (range 246.0-270.0 g) of Sludge @ 40° F.

25 Grams (range 23.0-27.0 g) of Hypochlorous Acid, Solid Powder @ 40° F.

50 Grams (range 47.0-53.0 g) of Hydrated Lime @ 40° F.

45 Grams (range 42.8-47.2 g) of Treated Sand (with Ammonia) @ 38° F.

Note: When mix temperature went to 92° F. one hour later

It was 98.8° F., and then 2 hours later 89° F.

P

260 Grams (range 247.0-273.0 g) of Sludge @ 40° F.

20 Grams (range 18.0-22.0 g) of Solid Hypochlorous Acid @ 40° F.

50 Grams (range 47.0-53.0 g) of Hydrated Lime @ 40° F.

Note: When mixed later the temperature went to 105.6° F.

then one half hour later it was 105.3° F.

Section: Modified With Formaldehyde

Q

248 Grams (range 238.0-260.0 g) of Sludge

23 Grams (range 21.0-25.0 g) of Solid Hypochlorous Acid

10× (range 8.0-12.0×) Formaldehyde

Note: All above were placed in a heated oven at 80° F. for two hours.

Next the “seed” was placed in a incubator for 24 hours at 70° F.

R

500 Grams (range 475.0-525.0 g) of Sludge

2.5 Grams (range 2.30-2.70 g) of Chlorine

75 Grams (range 71.0-79.0 g) of Lime

2.5 Grams (range 2.30-2.70 g) of Treated Sand

10 Milliliters (range 8.0-12.0 ml) of Alcohol

Let stand for 10 hours at room temperature, then put the seed bottle in the incubator for 24 Hours, add Colilert to the bottle.

S

250 Grams (range 238.0-262.0 g) of Sludge

20 Grams (range 18.0-22.0 g) of Chlorine

50 Grams (range 47.0-53.0 g) of Lime

8 Grams (range 14.30-15.70 g) of Treated Sand

8 Milliliters (range 6.50-9.50 ml) of Alcohol

Two hours later put the seed bottle in the incubator for 24 hours and add more Colilert

T

250 Grams (range 238.0-262.0 g) of Sludge

2.5 Grams (range 2.30-2.70 g) of Chlorine

50 Grams (range 47.0-53.0 g) of Lime

20 Grams (range 18.0-22.0 g) of Treated Sand

Two hours later put the seed bottle in the incubator and add more Colilert.

U

500 Grams (range 475.0-525.0 g) of Sludge Treated Lime

8 Grams (range 76.0-8.40 g) of Treated Sand

10 Milliliters (range 8.0-10.0 ml) of Alcohol

20 Milliliters (range 19.0-21.0 ml) of Ammonia

Two hours later put the seed bottle back in the incubator and add more Colilert.

Production

I. Producing 5-5-5 Fertilizer

The production of multinutrient fertilizer described on preceding pages is a fertilizer containing several additives; sludge, hydrated lime, liquid ammonia, ammonia prills, phosphate (P2O5), potash (K2O), sand impregnated with liquid ammonia and solid hypochlorous acid. Small amounts of formaldehyde and phenols and/or the Electron-Beam will finalize any pathogen control needed.

Table 1 illustrates the components of 5-5-5 fertilizer to be produced. Specific quantities of Nitrogen, phosphate and Potash are included to make one hundred pounds (100 lbs.) of each. As table I indicates, fertilizer units refers to 20 lbs. or 5 units in 100 lbs. thus, the 5-5-5 fertilizer.

Table I also illustrates how the lime component is used as pH adjustment to reach a pH of 12 (range 12.0-13.5 pH) to destroy pathogens.

II. Steps in Fertilizer Production

Steps are outlined for the production of fertilizer on pages that follow describing each step and block diagram displaying each sequence.

Table A—Chemical Guidelines for Usage

Table a—Chemical Guidelines for Sludge gives a list of regulated heavy metals and their maximum regulatory level. We will not use sludge from wastewater treatment plants that are over these levels.

TABLE 1
ORGANIC FERTILIZER COMPOSITION OF 5-5-5

| | Total Weight of | Portion of Total Weight Providing Usable | | |
|---|---|---|---|---|
| | Ingredients per | Nutrients | | |
| | Ton of Product | Nitrogen | Phosphorus(P₂0₅) | Potassium(K₂0) |
| Organic Sludge* | 1,800 lbs. | 61 lbs. | 69 lbs. | 11 lbs. |
| Chemical Additives: | | | | |
| Urea/Ammonia | 83 lbs./equivalent | 39 lbs. | | |
| P₂0₅ | 31 lbs. | | 31 lbs. | |
| K₂0 | 89 lbs. | | | 89 lbs. |
| Totals: | 2,003 lbs. | 100 lbs. | 100 lbs. | 100 lbs. |
| Weight of Usable | 300 lbs. | 100 lbs. | 100 lbs. | 100 lbs. |
| Nutrients for | | | | |
| 5-5-5 Fertilizer | | | | |
| Units Available | | 5 | 5 | 5 |
| (“Unit” refers to | | | | |
| 20 lbs., or 1% of | | | | |
| a ton in nutrients | | | | |

100 lb. Limestone CaO (1.5% Mg) for a pH adjustment

| | | | |
|---|---|---|---|
| Equations: | 1) | 4P + 50₂ = 2 P₂0_{5 % P in P}₂0₅ | 62P/ = 44% 142 P₂0₅ |
| | | 124 + 160 = 284 | |
| | 2) | 4K + 0₂ = 2K₂0 % K in K₂0 | 39.1 K/ = 42% 94K₂0 |
| | | 156 + 32 = 188 | |

Organic sludge is dried to a point where it contains 30% dried humus nutrients and only 70% water. The water content is needed to facilitate handling and assure activation of the humus and nutrients in soil. ** Only approximately 47 or 48 percent of the urea activates as usable nitrogen, necessitating a higher weight of urea in the mix than is the case for P205 and K20.

II. Steps in Fertilizer Production

1. Wastewater Treatment Plants in the United States produce both digested and undigested sludge which we will use as a base for the fertilizer.

2. All sludge will be tested for heavy metal organic compounds, and pathogens. Sludge with chemicals below the Maximum Contamination Level (MCL) will be used. (see Table a “Chemical Guidelines for Sludge”, page 32.)

3. Conveyors, trucks, or ocean barges will transport the municipal sludge to a processing plant.

4. The sludge will be stockpiled in a protected area.

5. Next, the sludge may be further dried and the dried sludge will be loaded onto a conveyor belt to be treated.

6. An electron beam (150 KW/3 mev) (range 75.0-200.0 KW/2.0-4.0 mev) will impart beams of electrons to kill pathogens in sludge or chemicals will be added to destroy the pathogens.

7. A conveyor belt then empties the treated sludge into a large mixing chamber where micro and macro nutrients are added to make a 2-2-2 or other grade fertilizer (hydrated lime, potash, phosphate, ammonia prills, ammonia liquid, urea, HClO, phenol or formaldehyde).

8. After the material is thoroughly mixed a conveyor belt will carry the fertilizer onto a hopper.

9. Mechanical transports, such as truck or barges, then will carry the finished product either to a bagging station or bulk storage facility.

10. The bagged bulk fertilizer is then stored for shipping in a protected building.

TABLE A
CHEMICAL GUIDELINES FOR SLUDGE

| | Title 360 | Maximum Level |
|---|---|---|
| | Maximum Regulatory | Agricultural Soil |
| Parameter | Level (mg/kg) | (lbs./acre) |
| (v) Cadmium, ppm | 25 | 3-4 |
| (vi) Zinc, ppm | 2500 | 150-223 |
| (vii) Copper, ppm | 1000 | 75-112 |
| (viii) Nickel, ppm | 200 | 30-45 |
| (ix) Lead, ppm | 1000 | 300-446 |
| (x) Chromium, ppm | 1000 | 300-446 |
| (xi) Mercury, ppm | 10 | |
| (xxi) Total Cyanide, ppm | | |
| PCB | <10 | |
| TOX | <10 | |

The above outline illustrates those heavy metals in sludge regulated under Title 360 which refers to the solids or semisolids resulted from the treatment of wastewater from wastewater treatment plants. Also, the maximum contamination level (MCL) for heavy metals for land application are listed.

III. A Customized Formula of Micronutrients in Fertilizer for Human Health

The mineral content of food varies with local soil and water conditions. Soil rich in nutrients provide us with the minerals essential to the body's important metabolic processes.

A special formulas consisting of the micronutrients * listed in Table b has been developed. The table gives the chemical name, amount in grams added and the minimum daily requirements that these additives supply. The micronutrient additives are used along with the special combination of additives described. These micronutrients, when added to the soil, along with the macronutrients, will improve the mineral content of the food, adding to the overall health of the population using this special fertilizer.

Over time, components of the customized formula will improve the following physiological functions of the body: immune defenses, nerve functions, protein synthesis, and energy utilization. In addition, this special formula decreases anemia, and facilitates many other metabolic processes, including basal metabolic rate. It also promotes an increase in strong bone function, thus over an extended period of time the body is protected from oxidation and aging.

These physiological functions are improved through the activation of large biochemical molecules and the use of catalysts in this process. Other ingredients serve as structural centers of enzymes as well as constituents or activators of enzymes.

*These special micronutrients contain the following trace amounts: <1 mg/L of fluoride, iron, iodide, magnesium and manganese.

TABLE B
MICRONUTRIENT ADDITIVES FOR FERTILIZER

| Name | Amount | % of MDR |
|---|---|---|
| Calcium | 250 (range 225.0-275.0) | 25% (range 22.5-27.5%) |
| | milligrams | |
| Iron | 15 (range 13.5-16.5) | 83% (range 77.0-91.0%) |
| | milligrams | |
| Iodine | 150 (range 135.0-165.0) | 100% (range 90.0-110.0%) |
| | milligrams | |
| Magnesium | 125 (range 112.0-137.0) | 31% (range 28.0-34.0%) |
| | milligrams | |
| Zinc | 15 (range 13.5-16.5) | 100% (range 90.0-100.0%) |
| | milligrams | |
| Selenium | 70 (range 63.0-77.0) | 36% (range 32.4-38.6%) |
| | micrograms | |
| Copper | 500 (range 450.0-550.0) | 25% (range 22.5-27.5%) |
| | micrograms | |
| Manganese | 4 (range 3.60-4.40) | 200% (range 180.0-220.0%) |
| | milligrams | |
| Chromium | 100 (range 90.0-110.0) | 83% (range 77.0-91.0%) |
| | micrograms | |
| Molybdnium | 50 (range 45.0-55.0) | 67% (range 60.3-73.3%) |
| | micrograms | |
| Potassium | 50 (range 45.0-55.0) | 1% (range 0.90-1.10%) |
| | milligrams | |
| Boron | 1 (range 0.90-1.10) | trace |
| | milligram | |

IV. E-Beam Applications

| | |
|---|---|
| Organic Removal | Solvents |
| Aroclors (PCBs) | Color Removal |
| BTEX | Odor control |
| Chemical warfare agents | Bacteria disinfecting |
| Explosives | Viral inactivation |
| Halogenated volatiles | DPB removal |
| Halogenated semivolatiles | TOC reduction |
| Non Halogenated volatiles | COD & BOD reduction |
| Nonvolatile semivolatiles | Phenols |
| Nonvolatile organics | PAH |
| Pesticides and Herbicides | |

Treatment performance is guaranteed only after feasibility/treatability studies have been completed for each application. The studies are designed to characterize the waste stream and thereby optimize treatment performance. Once these studies are completed, the E-Beam dose is used to accurately determine the equipment required.

The electron beam treatment system does not generate enough electron energy to induce nuclear activation. That is, the material being irradiated does not itself become radioactive. There is no radioactive residual left in either the treated waste stream or any structural equipment.

Since the E-Beam system contains no radioactive isotopes of any kind, the equipment is not radioactive. Personnel are shielded with either concrete (for transportable and permanent systems) or lead (for mobile systems). The shielding employed is sufficient to attenuate any generated X-rays to near background radiation levels. Once the electrical power is turned off, the generation of electrons and production of X-radiation is terminated.

Required permits are the same as for any industrial particleaccelerator or X-ray machine. These permits are easily attainable from state-level governmental agencies.

### The Novel Composition of this Invention

The novel composition of this invention is the use of municipal sludge and a basic formula of various chemical additives to formulate a commercial fertilizer. Standard commercial fertilizers are made up of various sources of phosphorus (phosphate), potassium (potash), and nitrogen (urea). The main ingredient of the new fertilizer is municipal sludge. Other additives such as gypsum, (calcium phosphate), lime/calcium oxide, hypochlorites and liquid ammonia are used for pH, odor, and pathogen control. Calcium hypochlorite, formaldehyde and phenol are used primarily for pathogen control. Finally, the use of an electron beam will further reduce toxic organic chemicals and pathogens. An electron beam with the rating of 150 KW and 3 mev (range 75.0-200.0 KW and 2.0-5.0 mev) is used.

1. A method of producing a municipal based sludge fertilizer by mixing the following: municipal sludge: (83.0%) (74.4-90.0%), comprised of solids: (30.0%) (27.0-33.0%), liquids: (70.0%) (63.0-77.0%). In addition lime: (12.5%) (11.2-13.7%), liquid ammonia prills: (1.30%) (1.20-1.40%) (1.30%), potash: (1.20-1.40%) phosphate: (1.30%) (1.20-1.40%), calcium: (1.0%) (0.5-1.5%), liquid ammonia: 2.5 gallons (2.25-2.75 gal) of (50%) (40.0-60.0%) concentration.

2. A method of producing a sludge fertilizer in accordance with claim 1 in which 1.0% (range 0.50-1.50%) calcium hypochlorite or potassium hypochlorite (5%) is used to control pathogens and odors in the municipal sludge.

3. A method of producing a sludge fertilizer in accordance with claim 1 in which 10.83 g (range 9.75-11.91 g) of formaldehyde (37%) (range 33.3-40.7%) and 10.71 grams (range 9.64-11.78) phenol is added as a topical spray to reduce pathogens.

4. A method of producing a sludge fertilizer in accordance with claim 1 in which 10.0% (range 7.5%-12.5%) calcium sulfate (CaS04-2 H₂O) is used to control moisture so that the sludge is 30% (25%-35%) solids and 70% (63%-77%) moisture and to condition the soil, to assist in controlling odors and pH in municipal sludge. In addition, calcium sulfate in the form of CaSO₄ and CaSO₄-H₂O (Plaster of Paris) may be substituted for the CaSO₄-2H₂O (Gypsum).

5. The substance composition as recited in claim 1 is subjected to an electron bean with the power of ((75.0-200.0 KW) and (2.0-4.0 mev)) to destroy toxic chlorinated hydrocarbons such as PCBs, solvents, pesticides and herbicides, penols, polyaromatic hydrocarbon, phenols, odor, bacteria disinfecting and viral inactivation.

6. The substance composition as recited in claim 1 is used as a base for the addition of a customized formula of micronutrients in fertilizer for improved human health. (See Table b, page 38.)

7. The substance composition as recited in claim 1 is used as a base to control odors. In one embodiment, agriculture lime, ammonia prills and liquid ammonia are used to modify odors to make the resulant odors less intense and more tolerable. In another embodiment commercial odor neutralizers may be used. In another embodiment, air oxidation occurs with a direct flame combustor is used. In yet another embodiment on electron beam [(75.0-200.0 KW) and (2.0-4.0 mev)] may be used to finalize odor neutralization. Finally in yet another embodiment, calcium and potassium hypochlorite will reduce odors over 98%.

8. Claims 1-7 above refer to municipal based sludge; in addition, poultry, pig and other animal waste sludge may be used for fertilizing farmland using the same additives in the same proportions and for the same reasons.
